(19) United States
(12) Patent Application Publication
(10) Pub. No.: US 2002/0012487 A1
(43) Pub. Date: Jan. 31, 2002

(54) Polarization mode dispersion generator

(75) Inventor: Jay N. Damask, Annapolis, MD (US)

Correspondence Address: YAFO NETWORKS, INC., 1340 F CHARWOOD RD., HANOVER, MD, 21076, US

(73) Assignee: Yafo Networks, Inc., Hanover, MD (US)

(21) Appl. No.: 09/911,898

(22) Filed: Jul. 24, 2001

Related U.S. Application Data
(60) Provisional application No. 60/221,688, filed on Jul. 31, 2000.

(51) Int. Cl. G02B 6/26

(52) U.S. Cl. 385/15; 385/11; 385/39

(57) ABSTRACT

Methods and apparatus for generating polarization mode dispersion (“PMD”), especially for use in PMD emulators and compensators, are provided. The apparatus can include a lens assembly, an optical beam turning assembly, and a variable PMD generating assembly located between the lens assembly and the optical turning assembly. The variable PMD generating assembly can include a fixed DGD stage and a variable electro-optically controlled retardation stage. The method involves directing the beam through the variable PMD generating assembly at least twice by folding the beam with the turning assembly. Various phase and temperature compensation techniques are also provided.

### CROSS-REFERENCE TO RELATED APPLICATIONS

This claims priority under 35 U.S.C. 119(e)(1) to U.S. Provisional Patent Application No. 60/221,688, filed Jul. 31, 2000, which is hereby incorporated by reference in its entirety.

### FIELD OF THE INVENTION

The present invention relates to methods and apparatus for generating polarization mode dispersion, and particularly to methods and apparatus that compensate for polarization mode dispersion impairment using the generated dispersion.

### BACKGROUND OF THE INVENTION

Polarization mode dispersion (hereinafter, “PMD”) is generally recognized as a problem for high bit optical transmission rates that use, for example, time domain multiplexing. One solution to this problem is to adaptively compensate for the PMD.

PMD is caused by variations in birefringence along the optical path that causes the orthogonal optical signal polarization modes to propagate at different velocities. The primary cause of PMD is the asymmetry of the fiber-optic strand. Fiber asymmetry may be inherent in the fiber from the manufacturing process, or it may be a result of mechanical stress on the deployed fiber. Environmental changes are dynamic and statistical in nature, and are believed to result in PMD changes that can last for variable periods of time and vary with wavelength, with the potential for prolonged degradation of data transmission.

Thermal and mechanical effects, such as diurnal heating and cooling, vibration from passing vehicles, fiber movement in aerial spans, and cabling disturbances by craftspersons (e.g., during patch panel rerouting) have all been shown to cause first and higher order PMD. For example, optical pulses that have no dispersion can be transformed into pulses that display both first and second order PMD. These effects are known to momentarily increase the PMD in a fiber span and briefly affect the transmission quality of an optical signal. Because these effects are sometimes momentary, they are hard to isolate and diagnose. In fact, these types of problems are sometimes known as “ghosts” because they occur briefly and mysteriously, and cannot be replicated during a system maintenance window.

In long fiber spans, enough PMD can accumulate such that bits arriving at the receiver begin to interfere with others, degrading transmission quality. This effect becomes more pronounced as transmission rates get higher (and bit periods get shorter). Generally, PMD exceeding ten percent of the bit period is considered detrimental. At 10 Gbs, the bit period is 100 psecs, which implies that any span that exhibits PMD greater than 10 psecs may be “PMD-limited.” This generally only occurs in extraordinarily long spans, and those incorporating older fiber.

To date, spans deploying 10 Gbs rates have been specially selected or “link-engineered” to low PMD fibers. As the 10 Gbs data transmission rate standard becomes more prevalent, however, PMD challenged fibers must be deployed, or lit, and specialized engineering resources may become an alternative, though cost prohibitive. PMD is expected to be a significant and growing concern in systems transmitting information at 40 Gbs and higher. For example, at 40 Gbs, the PMD tolerance is only about 2.5 psecs. At this transmission rate, every span is potentially PMD-limited.

To understand conventional compensation techniques, it is first necessary to understand how PMD arises. Generally, PMD is introduced into an optical signal during transmission along an optical fiber because small stresses in the fiber induce eccentricities into the normally circular fibers. These eccentricities cause the light to propagate at slightly different velocities along two orthogonal directions. A typical fiber, which could be hundreds of kilometers long, normally undergoes varying degrees of stress along its length. That length can be approximated as a number of concatenated shorter sections in which the two propagating velocities are constant within each section. This is known to result in certain phase and temporal delays between the two polarization modes. The principal optical axis in various sections may be randomly oriented with respect to each other.

A PMD generator can be used to construct more sophisticated PMD equipment, including PMD compensators for use in fiber-optic transmission systems, such as wavelength-division multiplexed (hereinafter, “WDM”) systems, and PMD emulators.

FIG. 1, for example, illustrates a basic architecture for WDM transmission system 1. A number of laser transmitters 2, each with distinct center frequencies and with distinct signal information, generate separate optical signals. Using optical multiplexer (hereinafter, “MUX”) 4, the generated optical signals are combined and transmitted along optical transmission line 9. Transmission line 9 can include any number of fiber and optical amplifier stages (shown), each of which can act as PMD impairment sources. After transmission across line 9, the transmitted signal is separated by frequency with optical demultiplexer (hereinafter, “DMUX”) 6. Typically, each signal frequency is then detected at dedicated optical receiver 10.

In many systems, the transmission of the combined signal information impairs the signals as a result of PMD. Accordingly, PMD compensators 8 can be placed between optical DMUX 6 and receiver 10 to mitigate, in part or in full, the PMD impairment from the transmission of the combined signal. As shown in FIG. 1, one PMD compensator can be provided for each receiver.

FIG. 2 shows an illustrative block diagram of generic PMD compensator 20. During operation, PMD compensator 20 receives PMD-impaired optical signal 22. Within compensator 20, signal 22 is first received by polarization controller 24, which transforms the state of polarization of the optical signal for reception at PMD generator 26. Subsequent PMD generator 26 receives the optical signal from polarization controller 24 and transmits the optical signal to optical output 29 of PMD compensator 20. PMD compensator 20 is, in this respect, optically transparent. In order to generate a feedback signal that controls polarization controller 24 and PMD generator 26, a fraction of the optical signal, after passing through generator 26, is directed to receiver and error generator 21. Receiver and error generator 21 generates an error signal, which can be received by control-signal generator 28 that, in turn, controls the optical components of compensator 20.

The combination of polarization controller 24, PMD generator 26, receiver and error generator 21, and control signal generator 28, forms a closed-loop, dynamic feedback system. Polarization controller 24 and PMD generator 26 are normally controlled such that optical output 29 suffers minimal PMD impairment.

When a conventional PMD compensator fails, it not only does not compensate for PMD impairment, it may actually add undesirable PMD to the signal, further degrading its quality. Further optical degradation, however, should be avoided, whenever possible.

Also, some conventional PMD compensators can be undesirably large. For example, PMD compensators can be undesirably long because the maximum amount of optical retardation of a compensator is generally proportional to the length of the birefringent element used to retard one polarization component with respect to the other. Also, PMD compensators can be undesirably bulky because each of the input and output optical fibers is fixed to the device, usually with collimators. Two separate collimators, however, when attached to a device can be bulky and mechanically unstable.

It would therefore be desirable to provide methods and apparatus for robust PMD generation, especially for improved PMD compensation.

It would also be desirable to provide a PMD generator that does not further degrade an optical signal with additional PMD impairment when the generator is turned off or control is lost.

### SUMMARY OF THE INVENTION

It is therefore an object of the present invention to provide methods and apparatus for robust PMD generation, especially for improved PMD compensation.

It is also an object of the present invention to provide methods and apparatus for robust PMD generation that does not further degrade an optical signal with additional PMD impairment when the generator is turned off or control is lost.

These and other objects are accomplished in accordance with the principles of the present invention by providing a PMD generator, especially for use in a PMD compensator.

Accordingly, methods and apparatus for generating PMD are provided. An illustrative generator according to this invention can include a lens assembly at a first end of the generator, an optical beam turning assembly at the other end of the assembly, and a variable PMD optical assembly between the two ends. The lens assembly includes a two-fiber collimator, preferably a unitary dual-fiber collimator, for receiving a light beam from an input fiber and providing the processed light beam to an output fiber. The variable PMD optical assembly includes a fixed differential group delay (hereinafter, “DGD”) stage, and a variable retardation stage. According to a preferred embodiment, the variable retardation stage is electro-optically controlled.

A method of using the generator is also provided. The method includes: (a) providing a light beam through the input fiber into a lens assembly, (b) directing the beam through the PMD optical assembly two or more times by folding the beam at least once with the turning assembly, thereby imparting a certain amount of PMD on the light beam, and (c) receiving the processed light beam through the output. It will be appreciated that the amount of PMD imparted to the light beam can be zero or finite.

Another method according to this invention includes: (1) providing a light beam through the input fiber to the dual-fiber collimator input, (2) adding, through the DGD stage, a fixed amount of DGD to the light beam, (3) adding, through the variable retardation stage, a variable amount of retardation to the light beam, (4) redirecting the light beam, through the turning assembly, back through the variable retardation stage, (5) adding, through the variable retardation stage, the same amount of retardation to the light beam, (6) adding, through the DGD stage, the same fixed amount of DGD to the light beam, and (7) providing the light beam, through the output fiber, into the dual-fiber collimator output.

According to one aspect of the invention, the generator can be a null system using phase compensation techniques. As used herein, a null system is one in which the default PMD effect of the generator is substantially zero. This can be achieved by using optical phase compensation components, including, for example, phase-compensating waveplates that nullify the polarization retardation caused by the turning assembly. The waveplate provides an amount of polarization retardation can be equal in magnitude and opposite in direction from the polarization retardation caused by other elements within the turning assembly. For example, the magnitude of retardation can be substantially equal to modulus(2π). In one embodiment, the turning assembly can include a prism for double total-internal reflection and an appropriately designed compensating waveplate located facing the hypotenuse of the turning prism.

When the fixed DGD stage includes multiple birefringent elements, such as crystals, their e-axes can be aligned in a substantially parallel or perpendicular fashion. In one embodiment, there can be two temperature dependent complimentary crystal types. In this case, each crystal type exhibits a different temperature dependence, such that when the crystals are combined, the combination exhibits a temperature coefficient of expansion that is smaller than that of either of the crystal's coefficient individually. The two crystal types can be oriented such that their e-axes are either substantially parallel or perpendicular to one another. Also, the crystal lengths can have a ratio that depends on the specific temperature coefficients of the crystals. A third type of crystal having a relatively low birefringence can also be added to the fixed DGD stage to fine tune its optical length.

The relative orientation of the birefringent axis of the fixed DGD stage to the birefringent axis of the variable retardation stage can be an important generator design consideration according to this invention. Specifically, the e-axis of the fixed DGD stage and the p-axis of the variable retardation stage should be orientated relative to each other to provide for polarization mixing, or mode conversion, as the beam travels from one stage to the next.

As used herein, the term “e-axis” refers to the extraordinary axis of a uniaxially birefringent element or crystal and has a distinct refractive index from the other two orthogonal crystalline axes. The e-axis is intrinsic to the crystal and is based on the atomic crystalline structure. It will be appreciated that all birefringent elements are not uniaxial. A biaxial crystal, for example, exhibits a unique refractive index along each of the three orthogonal crystalline coordinates. Thus, in the case of a biaxially birefringent cystal, the term “e-axis” can be ambiguous. Rather, the three distinct refractive indices are associated with their respective coordinates. For the purpose of this invention, however, the term “e-axis” can refer to either the unique distinct axis of a uniaxially birefringent crystal or any of the three distinct axes of a biaxially birefringent crystal.

As also used herein, the term “principal axis” or “p-axis” refers to the birefringent axis of an electro-optic medium (crystalline or otherwise) and is the major axis of the electro-optically induced birefringence ellipse. That is, when an electric field is applied across an electro-optic medium, a voltage-induced birefringence occurs. That birefringence has a pointing direction referred to as the principal axis.

Thus, while the e-axis is intrinsic to the crystal and is present without the presence of an electric field, the p-axis is the birefringent axis induced by the presence of an electric field. Moreover, a crystal can possess both an e-axis and a p-axis, and the axes need not be parallel with one another.

As further used herein, the term “birefringent axis” is an axial orientation in a birefringent element, which the polarization state of an optical beam can pass such that the output polarization state is independent of optical frequency.

In one embodiment, the principal axis can be oriented either substantially parallel or substantially perpendicular to the vertex axis of the turning assembly, while the e-axis of the DGD stage is oriented at about ±45 degrees with respect to the vertex axis. Alternatively, if the principal axis and the e-axis are either substantially parallel or substantially perpendicular, a mixing half-wave waveplate can be inserted between the DGD stage and the variable retardation stage, such that the waveplate has an e-axis that is orientated at an angle of about ±22.5 degrees with respect to the e-axis of the DGD stage.

A birefringent axis of a birefringent element can be defined in terms of how an SOP of a polarized beam of light is transformed. In particular, the birefringent axis of a birefringent element is the axis that, when aligned with the optical beam, allows the beam to propagate such that its SOP transformation is independent of the beam's optical frequency.

As explained below, various additional optical components can be used to align the generator and make it more compact, including a straightening prism, a wedge prism, a polished support structure, and fiber lens arrays.

Further features of the invention, its nature and various advantages will be more apparent from the accompanying drawings and the following detailed description of the preferred embodiments.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 illustrates a basic architecture for a dispersion compensated wavelength-division multiplexed transmission system;

FIG. 2 shows an illustrative block diagram of a generic PMD compensator that can be used according to this invention;

FIG. 3 shows a perspective view of an illustrative PMD generator constructed according to this invention;

FIG. 4 shows another perspective view of the generator shown in FIG. 3, except that, for simplicity, all passive birefringent crystals have been combined into single representative crystal according to this invention;

FIG. 5 shows one possible set of relative e-axis orientations for three optical components in the generator of FIG. 4 according to this invention;

FIG. 6 shows the states of polarization of a light beam at numerous points during the beam's evolution through a PMD generator when no voltage is applied to the electro-optic crystal according to this invention.

FIG. 7 shows the states of polarization of a light beam at numerous points during the beam's evolution through a PMD generator when a voltage is applied to the electro-optic crystal according to this invention.

FIG. 8 shows the relative temporal displacement between the transverse electric and magnetic components of a light beam before, during, and after propagation through a turning prism according to this invention;

FIG. 9 shows the relative temporal displacement between the transverse electric and magnetic components of a light beam before, during, and after propagation through a turning prism in combination with a compensating waveplate according to this invention;

FIG. 10 shows perspective and top planar views of an illustrative retro-reflecting mirror, which uses two reflections to reverse the direction of the light beam according to this invention;

FIG. 11 shows the relative temporal displacement between the transverse electric and magnetic components of a light beam before, during, and after propagation through and reflections from thin-film coated surfaces of a turning prism according to this invention;

FIG. 12 shows a top planar view of a split turning prism in combination with a half-wave waveplate, and the relative temporal displacement between the transverse electric and magnetic components of a light beam before, during, and after propagation through the combination according to this invention;

FIG. 13 shows a perspective view of the combination of FIG. 12, taken along line 13-13 of FIG. 12, and the relative temporal displacements between and orientations of the transverse electric and magnetic components of a light beam before, during, and after propagation through the combination according to this invention;

FIG. 14 shows a perspective view of a turning prism and relative polarization components' orientations before and after a beam has been redirected with a turning prism, effectively reversing the direction of the horizontal components by mapping the rightward components to the left and the leftward components to the right, according to this invention;

FIG. 15 shows a perspective view of an electro-optic crystal in combination with a turning prism, where the crystal has an ellipsoid axis oriented at about 45 degrees with respect to the vertex of turning prism according to this invention;

FIG. 16 shows a perspective view of the electro-optic crystal and turning prism of FIG. 15, in an unfolded geometry, according to this invention;

FIG. 17 shows a perspective view of the combination shown in FIG. 15, further including a half-wave waveplate having an e-axis that is oriented at about 22.5 degrees with respect to the vertex of the turning prism according to this invention;

FIG. 18 shows a perspective view of the combination of FIG. 17, in an unfolded geometry, according to this invention;

FIG. 19 shows a perspective view of an illustrative collimation device, including dual-fiber ferrirule, collimating lens, and straightening prism, according to this invention;

FIG. 20 shows a perspective view of another illustrative collimation device with separate lenses used to collimate the beams carried by input and output fibers according to this invention;

FIG. 21 shows a perspective view of another illustrative collimation device including a support structure and one lens array for each of the fibers according to this invention;

FIG. 22 shows a perspective view of yet another illustrative collimation device including a dual fiber collimator lens assembly, including a dual-fiber collimator lens, a straightening prism, and a wedge prism according to this invention;

FIG. 23 shows a perspective view of still another illustrative collimation device including two fiber collimator lenses that are tilted with respect to a wedge prism according to this invention;

FIG. 24 shows a perspective view of a DGD stage that includes a single passive birefringent crystal according to this invention;

FIG. 25 shows a perspective view of a DGD stage that includes a plurality of passive birefringent crystals according to this invention;

FIG. 26 shows a perspective view of a DGD stage that includes at least two types of passive birefringent crystals according to this invention;

FIG. 27 shows a perspective view of a DGD stage that includes at least three types of passive birefringent crystals according to this invention;

FIG. 28 shows a perspective view of a part of an illustrative PMD generator, including a single electro-optic element, a mixing half-wave waveplate, and a turning prism according to this invention;

FIG. 29 shows a perspective view of a part of another illustrative PMD generator, including a single electro-optic element, a mixing half-wave waveplate, and a turning prism according to this invention;

FIG. 30 shows a perspective view of a part of yet another illustrative PMD generator, including multiple electro-optic elements, a mixing half-wave waveplate, and a turning prism according to this invention;

FIG. 31 shows a perspective view of a part of yet another illustrative PMD generator, including two electro-optic elements, a mixing half-wave waveplate, a crossing half-wave waveplate, and a turning prism according to this invention; and

FIG. 32 shows a schematic block diagram of an illustrative PMD compensator including a PMD generator according to this invention.

### DETAILED DESCRIPTION OF THE INVENTION

Methods and apparatus for controllably generating PMD are provided. The mechanically and optically stable generation of PMD can be used in a number of applications, and can be particularly useful in simplifying the overall dynamic operation of a closed-loop PMD compensator.

A PMD generator according to this invention at least includes a lens assembly for receiving a light beam from an input fiber and providing the beam to an output fiber, a beam-turning assembly for redirecting the beam from the input fiber to the output fiber, and a variable PMD generating assembly located between the lens assembly and the beam-turning assembly. The PMD generating assembly includes a fixed DGD stage and a variable retardation stage.

In a preferred embodiment, the variable retardation stage includes an electro-optical material, such as lithium niobate or lead lanthanum zirconium titanate. The DGD stage can be, for example, any passive birefringent material, such as YVO₄. Together, the fixed and variable stages generate and control PMD with two DGD stages having one degree of freedom. It will be appreciated that any of the stages, the lens assembly, and turning assembly can include one or more optical elements.

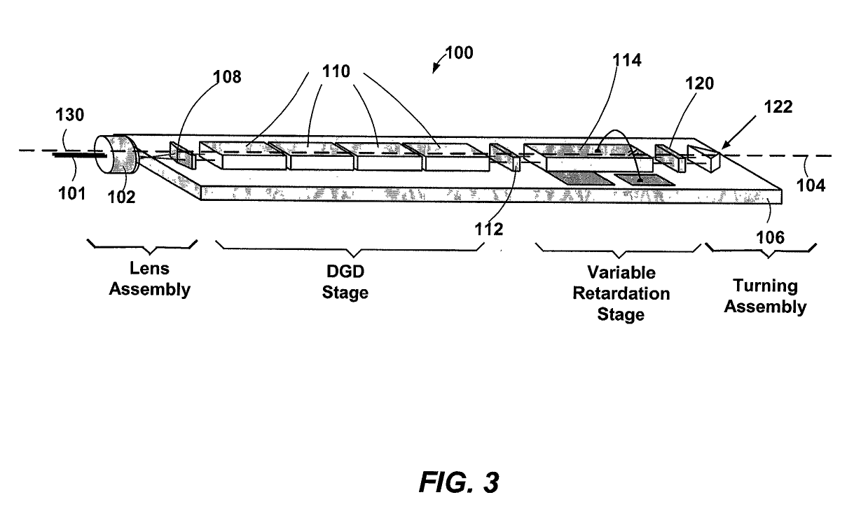

FIG. 3 shows a perspective view of illustrative PMD generator 100 constructed in accordance with the present invention. During operation, a light beam can be provided to generator 100 from optical fiber 101 through lens assembly 102 (e.g., a collimating lens). If lens assembly 102 includes a dual-fiber ferrirule, the collimated beams emerging from and returning to the lens propagate at a small diverging angle with respect to longitudinal axis 104 of substrate 106 (e.g., quartz). To correct for this divergence, straightening prism 108 redirects the beams so that they are substantially parallel to axis 104.

After lens assembly 102, the beam travels from left to right, which, as shown in FIG. 3, is considered the first pass or the “forward” direction.

One or more birefringent crystals 110 can be mounted to the surface of substrate 106 and, preferably, with the e-axes substantially parallel or substantially perpendicular to each other. Crystals 110 induce DGD between the two orthogonal polarization components of the beam traveling in the forward and later in the backward directions. The amount of induced DGD is determined by the length and birefringence of the crystals.

Mixing half-wave wave plate 112 receives the light beam traveling in the forward direction and “rotates” the beam's polarization state by about 45 degrees, which mixes, or retards with respect to the other, the two polarization states that emerge from the DGD stage. The extraordinary axis of the mixing waveplate can be, for example, about 22.5 degrees with respect to the e-axis of the DGD stage.

After mixing half-wave plate 112, the mixed light beam propagates through the variable retardation stage, which includes one or more variable retarders, such as electro-optic crystals, liquid crystals, and the like. For simplicity, however, the variable retardation stage will be described as single electro-optic crystal 114. Electro-optic crystal 114 can be cut such that a corresponding EO ellipsoid elongates along a direction that is substantially parallel or substantially perpendicular to the e-axis of the DGD stage. Thus, when a varying voltage is applied to crystal 114, the retardation of crystal 114 varies, which in turn controllably mixes, or retards with respect to the other, the two orthogonal polarization states that emerge from the DGD stage.

After crystal 114, the forward traveling light beam enters the turning assembly, which can include, among other things, prism-phase compensating waveplate 120 and turning prism 122. First, waveplate 120 imparts a retardation between the orthogonal polarization components traveling along their respective axis, which are substantially parallel and perpendicular to the vertex axis in anticipation of the phase delay induced by turning prism 122. As explained more fully below, total internal reflection (hereinafter, “TIR”) within prism 122 can be used to reverse the direction of the forward beam.

After turning prism 122, the reversed, or “backward” directed beam, sequentially propagates through compensating waveplate 120, electro-optic crystal 114, mixing waveplate 112, and birefringent crystals 110, which completes the processes of phase compensation, polarization state mixing, polarization state rotation of about 45 degrees, and DGD addition, respectively. Straightening prism 108 redirects the beam direction back into collimating lens assembly 102, which focuses the beam into optical fiber 130.

In general, a PMD generator with two DGD stages can yield four impulses for each input pulse in the time domain. According to this invention, however, the folded (e.g., double-pass) symmetry ensures that the forward and backward beams experience nearly identical amounts of DGD. This causes two of the four impulses to be temporally coincident, yet orthogonal in polarization. Thus, depending on the voltage applied to crystal 114, one, two, or three distinct impulses can be generated. In the case that only one impulse is generated, the generator acts as a null system—imparting essentially no PMD to the propagating light beam.

It will be appreciated that the folded PMD generator according to this invention can allow a light beam to pass any number of times through the variable PMD generating assembly. For example, when the number of passes is greater than two, the turning assembly can include two turning subassemblies, one at each end of the device.

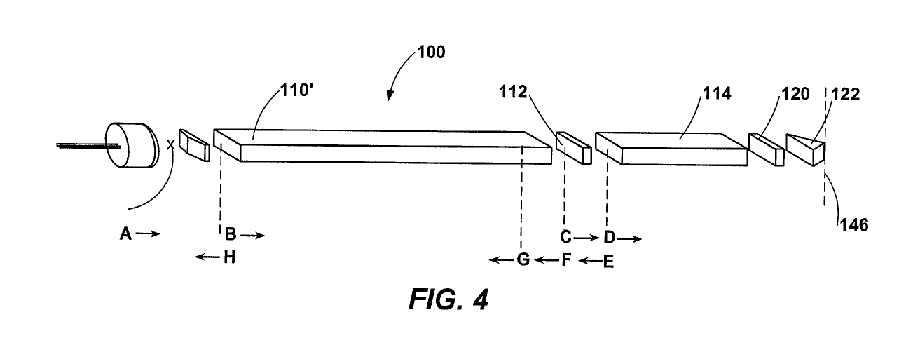

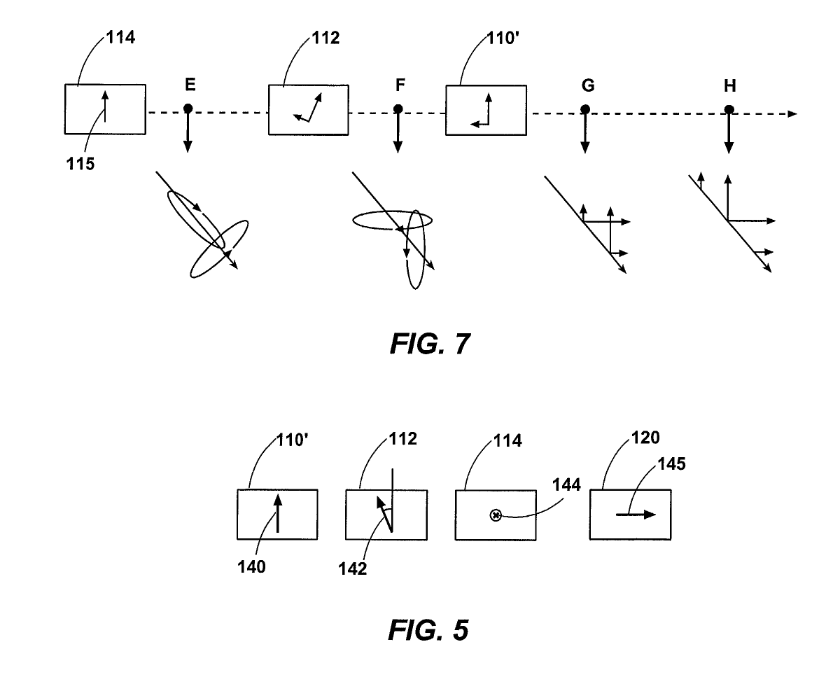

FIG. 4 shows another perspective view of generator 100, except that all passive birefringent crystals 110 have been combined into single representative crystal 110′. Without loss of generality, FIG. 5 shows one possible set of relative orientations for optical components 110′, 112, 114, and 120. As shown in FIG. 5, e-axis 140 of crystal 110′ can be oriented vertically, e-axis 142 of crystal 112 can be oriented at an angle of about 22.5 degrees from vertical, e-axis 144 of crystal 114 can be oriented longitudinally into the paper, and e-axis 145 of crystal 120 can be either substantially parallel or substantially perpendicular to vertex axis 146, which, as shown in FIG. 4, is oriented vertically in this example. It will be appreciated, however, that the use of the term “vertical” in this and other descriptions is used solely for illustrative simplicity and that the entire assembly can be positioned in any convenient way.

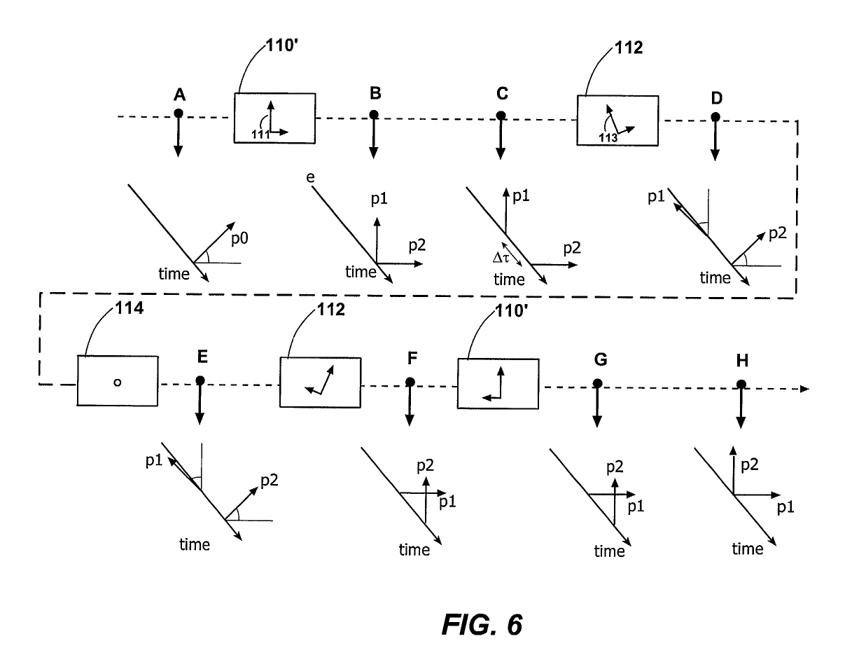

FIG. 6 shows the light-beam polarization states and temporal impulse response at numerous points A-H (as shown in FIG. 4) during the beam's evolution through generator 100 when no voltage is applied to crystal 114.

At point A, the forward beam initially has single polarization component p₀. Although p₀ is shown as a linearly polarized impulse, it will be appreciated that the impulse is, in general, elliptical, and that the impulse response of the system does not change for any type of input polarization. At point B, where the beam enters the DGD stage, the forward beam can be described as having two orthogonal polarization components (i.e., p₁ and p₂) that are aligned with the birefringent axes 111 of crystal 110′. During evolution through crystal 110′, an amount of DGD is imparted with respect to the two polarization states at point C. Although FIG. 6 shows that the input and output states of polarization at point C are linearly polarized, it will be appreciated that this need not be the case.

Transmission of the light beam through crystal 112 modifies the SOP of the light (provided by the DGD stage) such that the new SOP is a mirror image (taken about the e-axis of mixing waveplate 112) of the original SOP. The e-axes 113 of crystal 112 can be oriented at about +22.5 degrees and the modified SOP is shown in FIG. 6 at point D. This SOP modification effectively mixes the P₁ and P₂ components into two 50% components on each axis. The orientation of the e-axis of crystal 112 is chosen to optimize the mixing effect.

No further polarization retardation occurs in crystal 114 as long as no voltage is applied to crystal 114. Thus, the backward directed beam at point E is an unaltered copy of the forward directed beam at point D. Redirection of the light beam by the turning assembly, however, effectively produces a mirror image (taken about the vertex axis) of the p-axis and e-axis of each of the elements during for return pass.

At point F, after passing through crystal 112 in the backward direction, a mirror image of the polarization components is formed about its e-axis (which now appears oriented at about −22.5 degrees with respect to the light beam). Subsequent propagation through the DGD stage eliminates the temporal shift between the two polarization components.

At point G, where the beam reenters the DGD stage, the backward beam can once again be described as having two orthogonal polarization components aligned with the birefringent axes of crystal 110′. During evolution through crystal 110′, the same fixed amount of DGD is once again imparted with respect to the two polarization states, yielding a single temporal pulse at point H.

The end result is that—when no voltage is applied—the polarization state of the light beam that exits device 100 is identical to the polarization state of the light beam that enters device 100. Thus, in this case, the generator has a null PMD effect.

FIG. 7 shows that a finite amount of retardation is imparted to the beam when a non-zero voltage is applied to crystal 114. It will be appreciated that application of a voltage to crystal 114 will cause no difference in the way the beam evolves from point A to point D. Beginning at point D, however, and as shown in FIG. 7, the beam undergoes a very different type of transformation through crystal 114. Moreover, after evolution through crystals 112 and 110′, a three-pulse profile is formed at point H, in contrast to the single pulse profile shown in FIG. 6.

In contrast to FIG. 6, where the orientation of the intrinsic birefringent axis of crystal 114 is shown to be directed “into” the paper, FIG. 7 shows that when a voltage is applied to opposite sides (e.g., top and bottom) of crystal 114, the voltage induced p-axis 115 extends between those sides (e.g., vertically). Thus, as the two linearly polarized impulses evolve from point D to point E, the retardation generated by crystal 114 changes the linear polarization states to elliptical (as shown in FIG. 7), such that the pointing directions of the resultant elliptically polarized impulses are unchanged.

Propagation of the light beam in the backward direction through mixing waveplate 112, which has an “apparent” e-axis oriented at about −22.5 degrees, forms a mirror image of the polarization ellipses. Therefore, at point F, the pointing directions of the ellipses are substantially parallel and substantially perpendicular to the birefringent axis of the DGD stage. After exiting waveplate 112, the two polarization ellipses impinge on the face of crystal 110′ so, at point G, the polarization ellipses are resolved into purely vertical and horizontal components, which are parallel with the two crystal birefringent axes.

Finally, the DGD imparted by crystal 110′ yields a generalized impulse pattern shown at point H. The pattern includes four separate impulses. The middle two impulses, however, are temporally coincident and distinguishable by polarization only.

Phase compensating waveplate 120 can be used to ensure that PMD generator 100 is a null system. Without a phase compensating waveplate, however, a phase shift normally accumulates during propagation through the turning assembly. This results because, when the forward moving beam is reflected backward using two total internal reflections, there is a natural phase shift that occurs between the transverse electric and magnetic (hereinafter, “TE” and “TM”) polarization components at each TIR. The TE field is that polarization component that is parallel to the surface of the TIR face. A simple TIR action delays the TM component more than the TE component. Thus, transit of the optical beam through the prism induces a retardation, or small temporal delay, between the two components. This delay results in a systematic bias of the PMD generator (i.e., DGD is accumulated), even in the absence of a control voltage applied to crystal 114.

To mitigate this bias, phase-compensating waveplate 120 can be added to generator 100. Although the location of waveplate 120 is shown adjacent to turning prism 122, it will be appreciated that waveplate 120 need not be located at that particular position. For example, waveplate 120 can be placed in the beam's optical path before turning prism 122 only (not shown), after turning prism 122 only (not shown), before and after turning prism 122 (shown in FIG. 9), or even within turning prism 122 (shown in FIG. 12). It will be appreciated that when the waveplate is placed within turning prism 122, the waveplate acts as a mixing plate. Preferably, waveplate 120 is designed to have a bias that compensates for the systematic bias introduced by the two TIR events within turning prism 122.

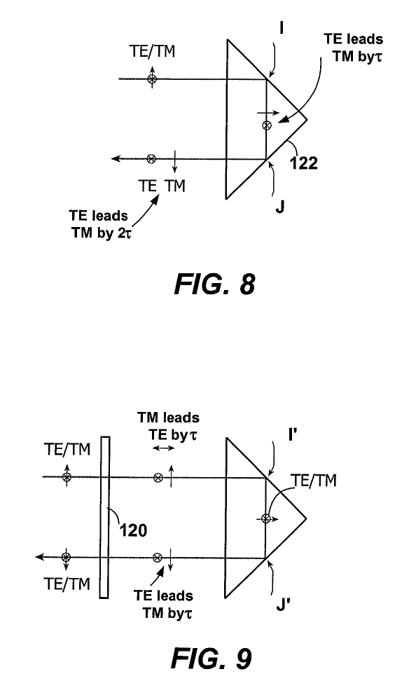

FIGS. 8 and 9 show how the addition of a properly designed compensating waveplate can substantially nullify the systematic bias introduced by turning prism 122. FIG. 8 shows the relative temporal displacement between the TE and TM components of a light beam before, during, and after propagation in turning prism 122. Initially, (before the beam is internally reflected at point I), the TE and TM components are temporally coincident. After reflection at point I, the TE component leads the TM component by a first amount τ. After the beam is reflected at point J, the delay induced through the prism is 2τ.

FIG. 9 shows prism 122 in combination with compensating waveplate 120. Like FIG. 8, FIG. 9 shows the relative temporal displacement between the TE and TM components of a light beam before, during, and after beam propagation in turning prism 122, except that waveplate 120 has been added. In this case, the TE and TM components are temporally coincident before they reach waveplate 120. After waveplate 120, but before reaching reflection point I′, the TM component leads the TE component by an amount τ. After reflection point II, but before reaching reflection point J′, the TM and TE components are again coincident. After reflection point J′, but before reaching waveplate 120, the TE component leads the TM component by an amount τ. And finally, after compensation waveplate 120, the TM and TE components are again coincident. Thus, a properly designed waveplate will yield a substantially zero systematic bias.

It will be appreciated that another phase compensation method is to delay one component with respect to the other an integral number of wavelengths.

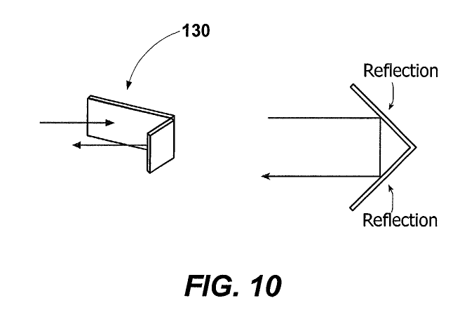

There are a number of “turning” options available for use with folded geometries according to this invention. As already explained above and as shown in detail in FIGS. 8 and 9, a turning prism can be used to fold the optical path using two TIR reflections. FIG. 10 shows retro-reflecting mirror 130, which can also be used to change the direction of a light beam. The retro-reflector uses mirrors, usually either metallic or dielectric, to generate an optical reflection. Like the TIR prism, each reflection can generate a certain amount of phase retardation that can be compensated with a phasecompensating waveplate.

Thus, the prism phase-compensation method according to this invention described above uses a custom waveplate that nulls the effect of phase retardation from the two TIR surfaces on the prism. Two additional alternative embodiments according to this invention are described below.

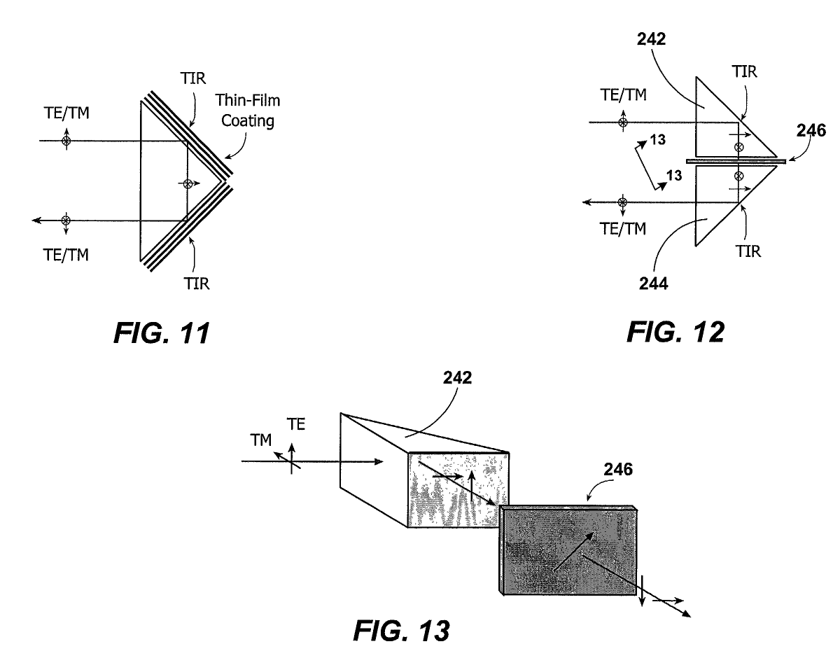

FIG. 11 shows one embodiment in which the two TIR surfaces are coated with a plurality of thin films. The design of the thin films can be chosen to increase the phase shift of the TIR from about 40 degrees, depending on the glass being used, to an integral multiple of about 360 degrees, or a full-wave shift. The actual design of thin films for phase compensation depends on the prism material (e.g., glass) and the particular coating materials. Coating procedures to effect phase compensation are well known.

FIG. 12 shows another embodiment for phase compensation according to this invention in which a prism can be split in half at its vertex. Once split, halves 242 and 244 can be separated and half-wave waveplate 246, which has an extraordinary axis at about 45 degrees with respect to the vertex axis, can be placed between halves 242 and 244. If desired, halves 242 and 244 and waveplate 246 can be attached, or bonded, together. In this embodiment, neither an external compensation plate nor a thin-film coating is required for compensation.

FIG. 13 shows a perspective view of the phase compensating waveplate/prism combination, taken along line 13-13 of FIG. 12, including the polarization orientations along the optical path. The function of center half-wave waveplate 246 is to mode convert TE to TM and TM to TE. While the first TIR leads the TE with respect to the TM, the two polarization components can be exchanged by half-wave waveplate 246, such that, after the second TIR, the two polarization components are temporally coincident.

The light beam transits the electro-optics at least twice—at least once in the forward direction and at least once in the backward direction. Care should be taken, then, to ensure that the retardation accrued during each pass through the crystal in the forward direction adds to the retardation accrued during each pass through the crystal in the backward direction. Thus, the polarization coordinate system established at the front face of the electro-optic element as seen by the light beam moving in the forward direction should be preserved as the light beam propagates through the same element in the backward direction. In other words, mode conversion between the forward and backward passes of the electro-optic element should be minimized, and preferably should be substantially zero.

Thus, according to this invention, the relative orientation of the p-axis of the variable retarder stage and the vertex of the turning assembly can be important. As discussed below, when the p-axis is oriented in a direction that is neither substantially parallel nor substantially perpendicular to the vertex axis, mode conversion results and, possibly, a degraded overall performance. Mixing waveplate 112 can be used to address mode conversion.

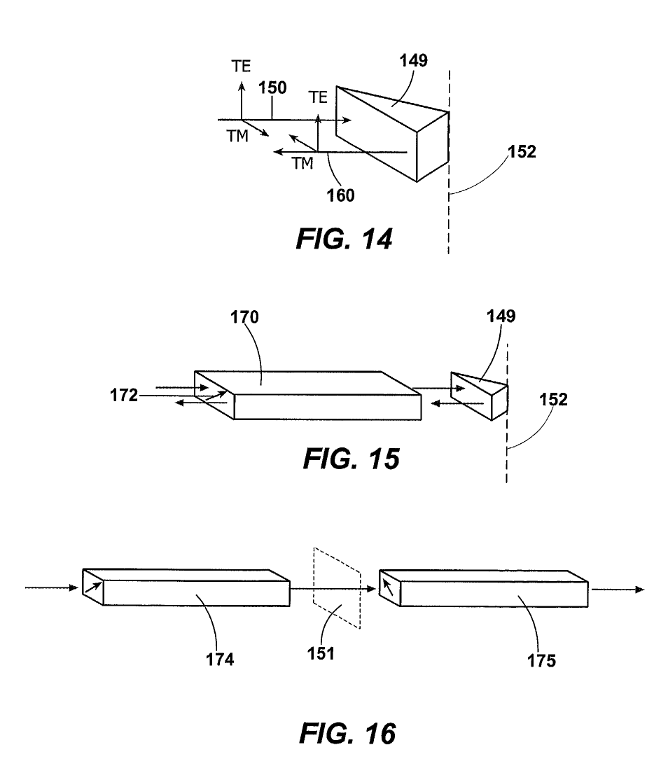

Before describing the effect of waveplate 112, however, the effect of turning prism 149 is described. FIG. 14 shows input beam 150 and output beam 160 with vertical and horizontal polarization components. Like a mirror, turning prism 149 reverses the direction of the horizontal components by mapping the rightward components to the left and the leftward components to the right. Upward and downward components, however, remain unchanged. For illustrative simplicity, relative retardation of the horizontal and vertical components is not shown.

FIG. 15 shows a perspective view of an electro-optic crystal in combination with a turning prism, where the crystal has an ellipsoid axis oriented at about 45 degrees with respect to the vertex of turning prism according to this invention. Electro-optic crystal 170 has p-axis 172, which is oriented at about 45 degrees with respect to vertex axis 152 of turning prism 149. To trace the beam through the two-component system, the folded geometry of FIG. 15 can be unfolded about vertex axis 152 to form an equivalent linear geometry, which is shown in FIG. 16. Thus, crystal 170 is illustratively split into two crystal halves 174 and 175 along its longitudinal centerline and rotating half 175 about vertex axis 152 of prism 149 by 180 degrees. In this case, prism 149 can be removed (leaving only prism plane 151) because the horizontal reversal effect has been accounted for. It will be appreciated that crystal half 175 has a p-axis having an orientation that is the mirror image of the ellipsoid axis of half 174. The lengths of halves 174 and 175 remain identical. As such, if the p-axis oriented at about ±45 degree angle with respect to the vertex axis, all phase retardation generated by half 174 is identically cancelled during subsequent propagation through half 175. At any other angle (except about 0 and about ±90 degrees), the retardation imparted by halves 174 and 175 is neither cancelled nor added arithmetically.

Thus, when an electro-optic crystal is combined with a turning prism, and the crystal has a p-axis that is oriented at about 45 degrees with respect to the prism's vertex, substantially zero phase retardation on the optical beam can be generated, regardless of the applied voltage.

As briefly described above, the optimal relative orientation of the birefringent axis of the DGD stage to the p-axis of the electro-optic stage is about ±45 degrees. However, it will be appreciated that the p-axis of the electro-optic material should not itself be oriented at about ±45 degrees in the face of the turning assembly. Therefore, the birefringent axis of the DGD stage can be oriented at about ±45 degrees with respect to the vertex axis and the p-axis of the electro-optic stage can be at about 0 degrees with respect to the vertex axis. Alternatively, a mixing half-wave waveplate can be inserted between the fixed and variable stages, wherein the p-axis of the electro-optic stage is either substantially parallel or substantially perpendicular to the vertex axis, and the birefringent axis of the DGD stage is either substantially parallel or substantially perpendicular to the p-axis.

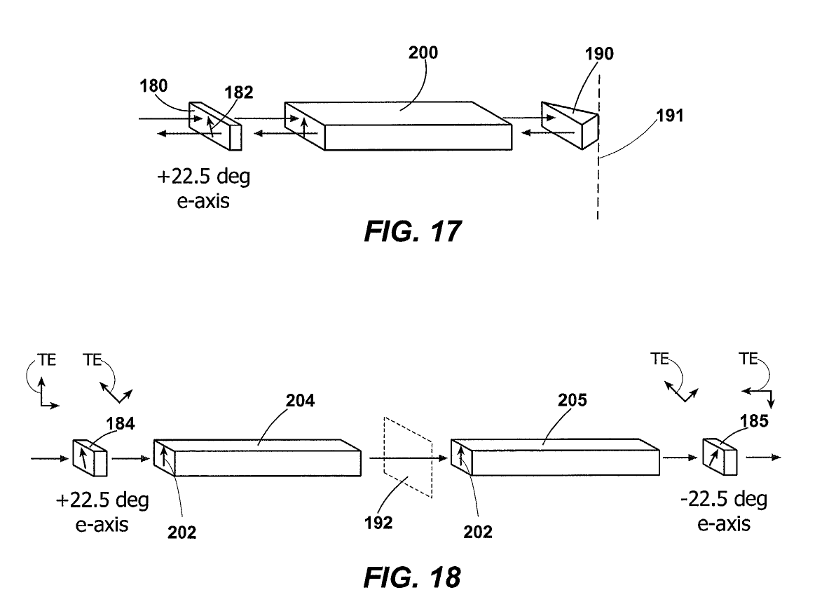

FIG. 17 illustrates the use of half-wave waveplate 180, which has its e-axis 182 oriented at about +22.5 degrees with respect to vertex axis 191 of turning prism 190. As also shown in FIG. 17, electro-optic crystal 200 is located between waveplate 180 and prism 190, with p-axis 202 (shown in FIG. 18) oriented substantially parallel to prism vertex axis 191 (i.e., a 0 degree p-axis).

FIG. 18 illustrates the unfolded equivalent of FIG. 17, using the same unfolding method explained above with respect to FIGS. 15 and 16. In this case, p-axes 202 of crystal halves 204 and 205, which are substantially parallel to the vertex axis, do not change their apparent orientations, even after the beam's propagation through turning prism 190. The unfolding process, however, does cause the relative e-axis orientation of mixing waveplate 180, to flip from about +22.5 degrees to about −22.5 degrees, as shown by halves 184 and 185. Once again, prism 190 can be removed (leaving only prism plane 192) because the horizontal reversal effect has been accounted for.

The polarization axes of the propagating light beam at several points along the optical path of the generator are illustrated along the top of FIG. 18. At the top left, the polarization axes are substantially vertical and horizontal due to the vertical e-axis orientation of the preceding DGD stage. Half-wave waveplate half 184 flips the optical axis about its e-axis to about +45 degrees. Forward and backward transmissions of an optical signal through crystal 200 (i.e., crystals 204 and 205) causes the signal to accumulate voltage-dependent phase retardation because prism 190 (i.e., plane 192) does not change the optical axis of the beam. Half-wave waveplate half 185 again flips the optical axis about the e-axis of the waveplate, which has an apparent direction of about −22.5 degrees. The result is that the optical axis is flipped on its side so that, from the left-most orientation to the right-most orientation, the vertical and horizontal components are interchanged. In other words, the transverse electric (“TE”) field of the light beam at the input of the device is orthogonal to the TE field of the light beam at the output.

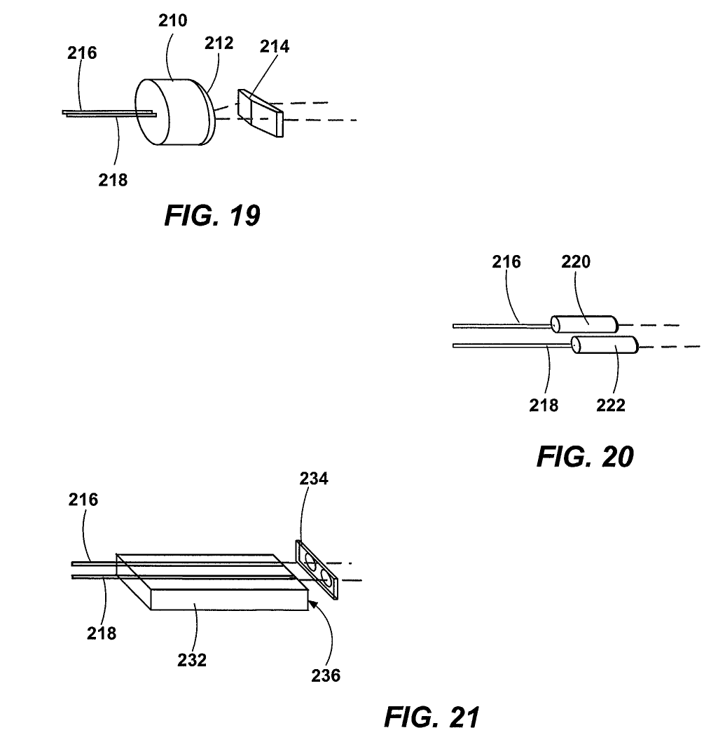

FIGS. 19-21 shows three illustrative devices according to this invention that can be used to collimate an optical beam that emerges from an input fiber and to refocus the returning collimated beam into an output fiber. Thus, it will be appreciated that although each of FIGS. 19-21 show light beams emerging from the optical fibers, that the direction could easily be reversed for one or both of the fibers. It will also be appreciated that, with appropriate modifications, any number of optical fibers can be used with these devices, although the number of optical fibers shown is only two.

FIG. 19 shows illustrative collimation device 210. Device 210 includes dual-fiber ferrirule 210, collimating lens 212, and straightening prism 214. Ferrirule 210 can be any mechanical fixture, such as a rigid tube, that can be used to confine the stripped ends of optical fibers or fiber bundles. As shown in FIG. 19, optical fibers 216 and 218 can be inserted in a parallel fashion into ferrirule 210 and lens 212 can be attached to the opposite end of ferrirule 210. It will be appreciated that lens 212 acts as both the collimating and focusing lens for both optical fibers. Straightening prism 214 makes parallel the otherwise diverging beams formed by the lens-ferrirule combination to make the beams parallel. The lens-ferrirule combination also advantageously makes the entire collimation assembly compact.

FIG. 20 shows another embodiment according to this invention in which separate lenses 220 and 222 are used to collimate the beams carried by fibers 216 and 218, respectively. In this case, a straightening prism is not required.

FIG. 21 shows yet another illustrative device for collimating and refocusing optical beams. The device includes V-groove support structure 232 (such as a silicon V-groove) or similar support structure, and lens array 234 for fibers 216 and 218. Fibers 216 and 218 are mounted in the support structure, which provides high levels of parallelism between the fibers and accuracy of center-to-center spacing. Also, end-face 236 of structure 232 is preferably polished, which helps to ensure that the focal planes of fibers 216 and 218 are substantially coincident. Lens array 234, manufactured, for example, using lithographic techniques, captures light emerging from its respective fiber and collimates it or focuses, depending on the direction of the light beam.

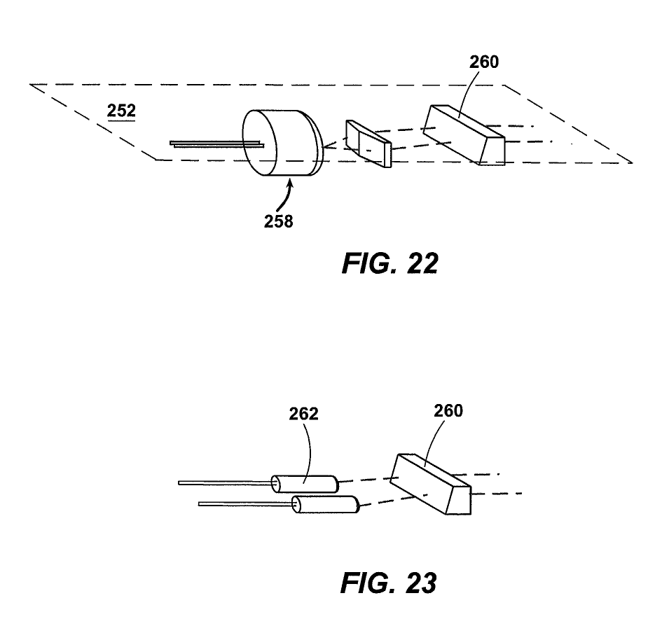

It will be appreciated that the optical beams can emerge at a “tilt” angle with respect to plane 252, which is defined to include parallel fibers 254 and 256. To compensate for this tilt, dual fiber collimator lens assembly 258 can be tilted in the opposite direction by an equal amount (not shown). In an alternative embodiment shown in FIG. 22, wedge prism 260 can be added. In this case, although the longitudinal axis of collimator assembly 258 is substantially parallel with plane 252, the emerging beams will tilt (e.g., upward) at some tilt angle. Wedge prism 260 captures the beams and, with a proper wedge angle, redirects the beams such that they again propagate in a direction that is parallel to plane 252. As discussed above, straightening prism 214 redirects the beams such that they are parallel with to each other. The use of wedge prism 260 is suitable for use with either dual-fiber collimating lens assembly 258, shown in FIG. 22, or with separate fiber collimators 262, shown in FIG. 23.

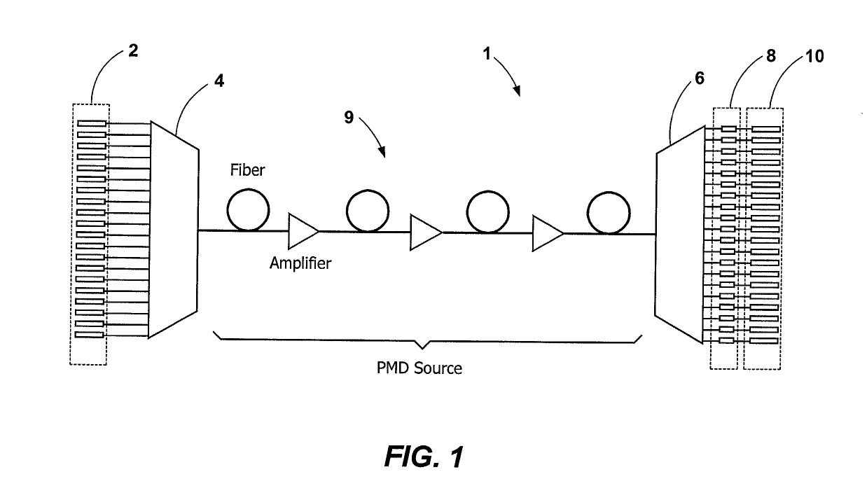

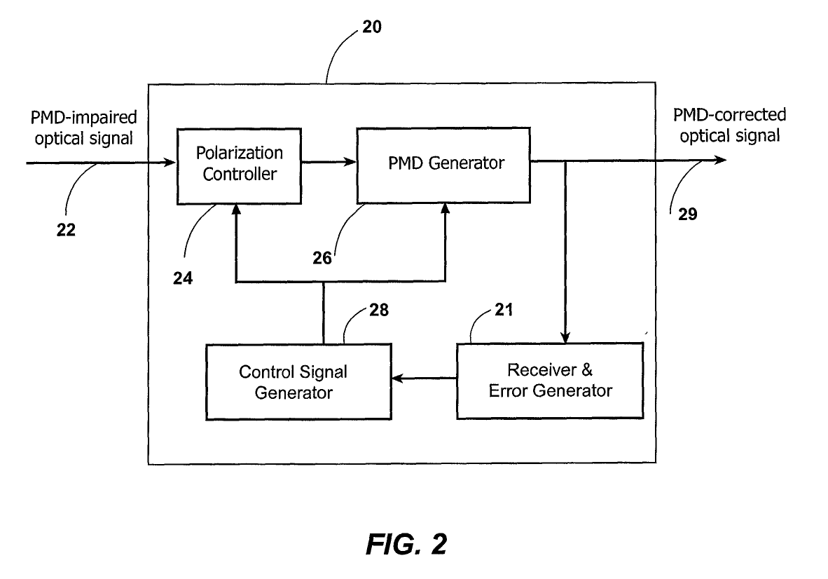

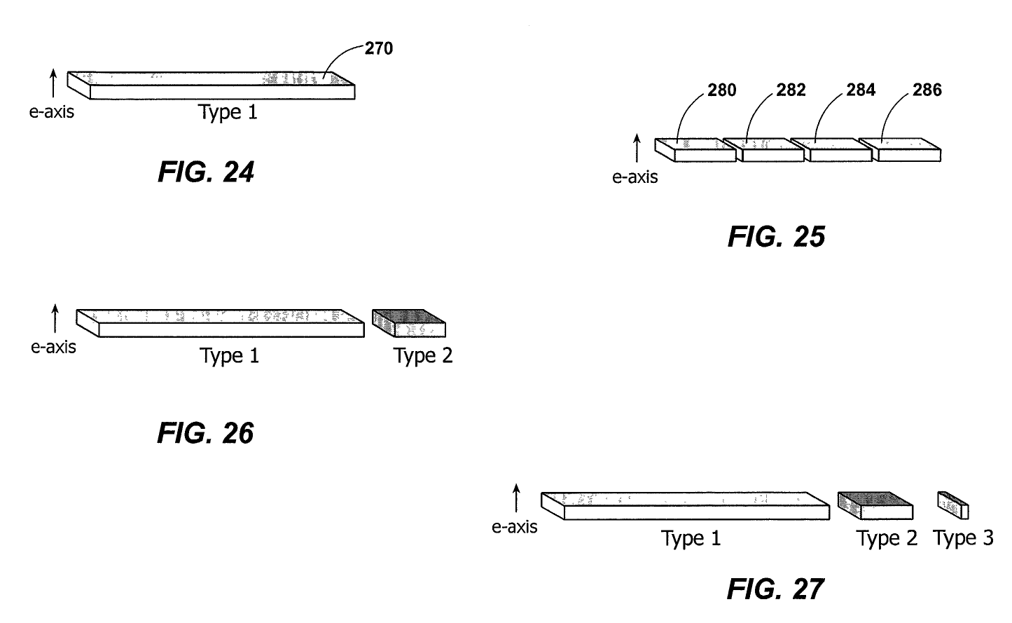

FIGS. 24-27 show various illustrative embodiments of fixed DGD stages and demonstrate that the passive birefringent crystal (e.g., crystal 110 of FIG. 1) can include one or more birefringent crystals.

FIG. 24 shows a first embodiment that includes single long crystal 270. It is the simplest embodiment to manufacture and well suited for simple DGD generation. As a practical matter, however, a long highly birefringent crystal is difficult to obtain. Accordingly, FIG. 25 shows another embodiment that includes a plurality of crystals 280, 282, 284, and 286, with equal or unequal lengths. In this case, the total length of all the crystals would be designed to be equal to the length of single crystal 270. Moreover, the e-axes of all crystals are preferably aligned in a parallel fashion.

The birefringence of a crystal assembly that includes a single material type will typically exhibit some temperature dependence. Therefore, the amount of DGD added to a propagating light beam depends on temperature as well. As shown in FIG. 26, one way of varying (e.g., decreasing) the temperature dependence of a crystal assembly according to this invention is to add a second, complimentary birefringent crystal, thus forming an effective composite crystal with a customized thermal dependence.

There are several combinations of crystal materials that have complimentary temperature coefficients; that is, temperature coefficients that, when combined, reduce the overall temperature coefficient of the combination. One such combination is a YVO₄ crystal and a lithium niobate crystal. In this case, the e-axes of the two crystals are preferably aligned in a parallel fashion. In other cases, the e-axes of the two crystals can be aligned in a substantially perpendicular fashion. The length ratio of the two complimentary crystals depends on the specific temperature coefficients of the crystals.

It can be difficult to prepare a crystal assembly having a length that must be controlled to within a single wavelength. For example, the wavelength of light inside a typical birefringent material can shrink from about 1.55 microns to about 1.0 microns. Thus, to prepare a crystal having a length to within 0.05 microns of a target length can be exceedingly difficult. This control, however, can be achieved according to this invention by adding a third birefringent crystal as shown in FIG. 27. As used herein, this crystal is referred to as a type 3 material and has a low birefringence. The thickness of the type 3 crystal can be chosen to fine-tune the optical length of the composite crystal formed from type 1 and type 2 crystals. One type 3 material that can be used according to this invention is crystalline quartz.

In addition to the fixed DGD stage, the variable retardation assembly, included in a PMD generator according to this invention, also requires at least one element constructed with a controllable, (e.g., electro-optic) material. As used herein, an electro-optic material is any material having a refractive index that can be modified by applying an electric field. Typically, an electro-optic material exhibits a birefringence in the presence of an applied electric field. Moreover, it will be appreciated that an electro-optic material used according to this invention can be uniaxially or biaxially birefringent.

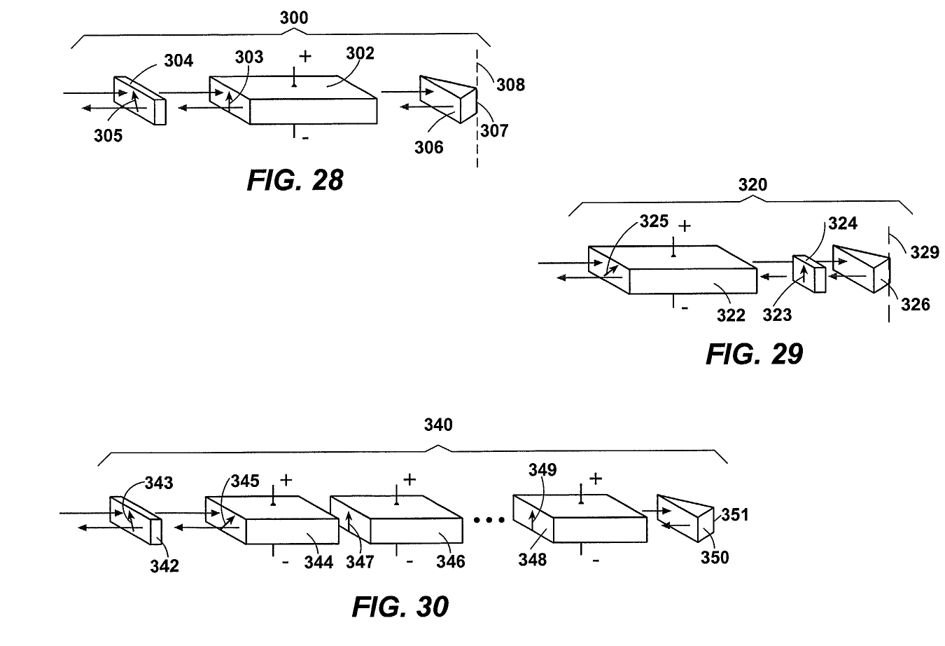

FIG. 28 shows a perspective view of a part of illustrative PMD generator 300, including single electro-optic element 302, mixing half-wave waveplate 304, and turning prism 306. As shown in FIG. 28, the angle between e-axis 305 of waveplate 304 and axis 308 of prism vertex 307 can be about 22.5 degrees. The orientation between p-axis 303 and vertex axis 308 is preferably either substantially perpendicular or substantially parallel.

FIG. 29 shows a perspective view of an illustrative portion of another PMD generator 320, which includes single electro-optic element 322, half-wave waveplate 324, and turning prism 326. In this case, half-wave waveplate 324 is located between crystal 322 and prism 326, and only one of the two propagating beams passes through waveplate 324. E-axis 323 is oriented vertically (i.e., parallel to vertex axis 329) to flip the horizontal polarization component from right to left (or vise-a-versa). Also, p-axis 325 can be oriented at any angle with respect to prism vertex 329.

FIG. 30 shows how multiple electro-optic elements or crystals can be used in yet another illustrative PMD generator 340 according to this invention. PMD generator 340, then, can include, among other components, half-wave waveplate 342, turning prism 350, and a plurality of electro-optic crystals 344, 346, and 348 between waveplate 342 and turning prism 350. It will be appreciated that, although only three electro-optic crystals are shown in FIG. 30, any convenient number of crystals can be used in accordance with this invention.

As shown in FIG. 30, the angle between e-axis 343 of waveplate 342 and prism vertex axis 351 can be at about ±22.5 degrees. Moreover, the electro-optic p-axes 345, 347, and 349 can be oriented in any manner, as long as the crystal closest to prism 350 (i.e., electro-optic crystal 348) has its p-axis aligned substantially parallel with vertex axis 351. The requirement that axis 349 be aligned with vertex 351 can be relaxed if an auxiliary waveplate is placed adjacent to turning prism 351 (as shown, for example, in FIG. 29).

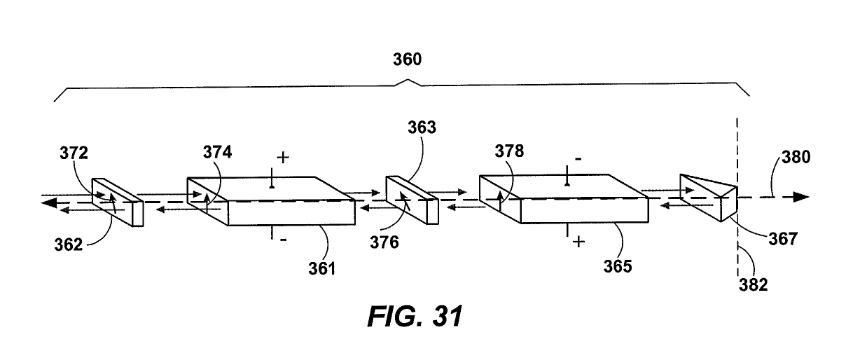

FIG. 31 illustrates another variable electro-optically controlled retardation stage according to this invention. Variable retardation stage 360 includes mixing have-wave waveplate 362, turning prism 367, and two electro-optic crystals 361 and 365 separated by crossing half-wave waveplate 363. Electro-optic crystals 361 and 365 can be cut, for example, such that their e-axes 374 and 378, respectively, are not parallel to the light beam (i.e., longitudinal axis 380 of device 360), but rather oriented substantially perpendicular to longitudinal axis 380. Thus, e-axes 374 and 378 of crystals 361 and 365, respectively, are preferably cut so they are parallel to vertex axis 382. In this orientation, DGD will accumulate during transit of crystals 361 and 365. To cancel DGD addition, crossing half-wave waveplate 363 can be inserted between crystals 361 and 365. Preferably, crossing half-wave waveplate 363 has its e-axis 376 oriented at a 45 degree angle with respect to prism vertex axis 382.

As the light beam propagates between crystals 361 and 365, crossing waveplate 363 mode converts the fast axis to the slow axis and the slow axis to the fast axis, thereby canceling intrinsic retardation and DGD. To avoid further cancellation of electro-optically induced birefringence, the directions of the voltages applied to crystals 361 and 365 should be different, and preferably opposite. This is because a linear electro-optic effect induces retardation with a sign that is the same sign as the applied voltage. Thus, with a positive voltage on one crystal and a negative voltage on the other, the electro-optically induced retardations add and the intrinsic birefringences cancel.

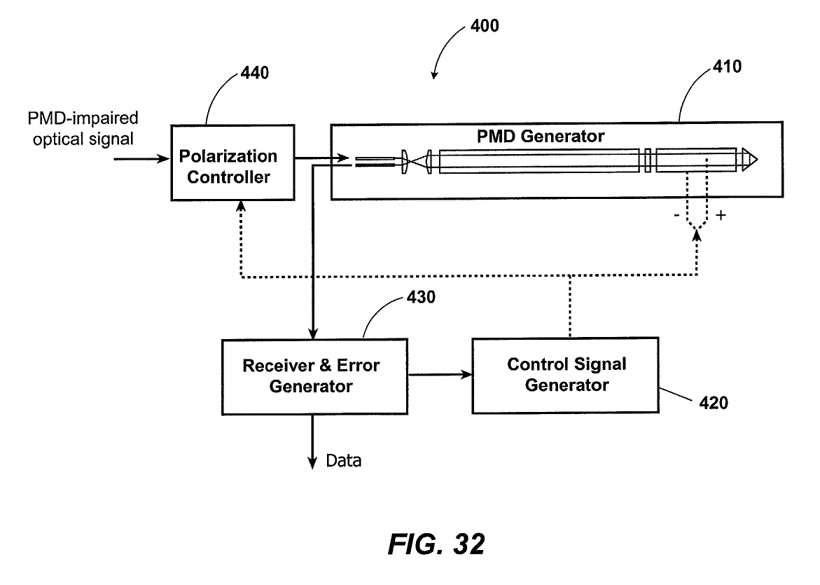

A PMD generator according to this invention can be used in a PMD compensator. FIG. 32 shows one such compensator 400, which includes PMD generator 410, control signal generator 420, receiver & error generator 430, and polarization controller 440. During operation, polarization controller 440 receives the optical signal of a single PMD-impaired channel. Such a controller can include, for example, a lithium niobate wave guiding polarization controller, a liquid-crystal stack, a bulk electro-optical crystal set, a fiber squeezer, or any combination thereof.

Polarization controller 440 transforms the state-of-polarization of the optical signal for reception at PMD generator 410. The optical signal then propagates through PMD generator 410 and, after further PMD accumulation that results from the DGD stages of the PMD generator, the signal is directed to receiver and error generator 430, which transforms the optical signal into an electrical signal, which may be an RF signal. Here, PMD impairment is detected in some manner and an error signal can be generated. The error signal can then be sent to control signal generator 420, which generates one or more control signals that are used to control the polarization controller 440 and the electro-optic crystals 410 located within the PMD generator in such a manner as to improve the optical signal quality as observed at the receiver.

Thus, a PMD generator for improved PMD compensation is provided. One skilled in the art will appreciate that the present invention can be practiced by other than the described embodiments, which are presented for purposes of illustration and not of limitation, and the present invention is limited only by the claims which follow.

I claim:

1. An optical PMD generator comprising:
a lens assembly for receiving a light beam from an input fiber and providing said light beam to an output fiber;
a beam-turning assembly for the redirection of the light beam from said input fiber to said output fiber; and
a variable PMD generating assembly located between said lens assembly and said beam-turning assembly, wherein said PMD generating assembly comprises:
a fixed DGD stage; and
a variable retardation stage.

2. The generator of claim 1 wherein said lens assembly is located at a first end of said generator and said turning assembly is located at a second end of said generator.

3. The generator of claim 2 wherein said variable PMD generating stage is located between said fixed stage and said turning assembly.

4. The generator of claim 1 wherein said turning assembly can reverse the direction of the beam an even number of times and said lens assembly comprises:
an input collimator at one end of the generator; and
an output collimator at another end of the generator.

5. The generator of claim 1 wherein said turning assembly can reverse the direction of the beam an odd number of times and said lens assembly comprises a two-fiber collimator.

6. The generator of claim 5 wherein said two-fiber collimator comprises dual-fiber collimator, wherein said dual-fiber collimator comprises a single lens, an input fiber, and an output fiber.

7. The generator of claim 1 wherein said lens assembly comprises:
a two-fiber collimator; and
a straightening prism between said collimator said variable PMD generating assembly, and wherein said straightening prism is positioned such that said beam, directly after passing through said straightening prism a first time, is substantially parallel to said beam, directly before passing through said straightening prism a second time.

8. The generator of claim 7 wherein said lens assembly further comprises a wedge prism located between said straightening prism and said variable PMD generating assembly.

9. The generator of claim 7 wherein said lens assembly further comprises a wedge prism located between said collimator and said straightening prism.

10. The generator of claim 1 wherein said lens assembly further comprises:
a support structure that holds said input fiber and said output fiber such that they are substantially parallel to each other; and
a lens array comprising
a first lens positioned at an end of said input fiber for collecting and collimating light emerging from said input fiber, and
a second lens positioned at an end of said output fiber for collecting and focusing light returning to the lens assembly.

11. The generator of claim 10 wherein said support structure holds said input and output fibers at a predetermined center-to-center spacing such that the focal planes of said input fiber and said output fiber are substantially coplanar.

12. The generator of claim 1 wherein said optical beam turning assembly comprises a turning element selected from a group consisting of a unitary turning prism, a retro-reflecting mirror, and a two-part prism.

13. The generator of claim 1 wherein said turning element provides a first amount of polarization retardation to an optical beam being turned by said element, and wherein said turning assembly further comprises a phase-compensating waveplate to substantially nullify the first amount of polarization retardation.

14. The generator of claim 13 wherein said second amount of polarization retardation is equal in magnitude to and opposite in direction from the first amount of retardation.

15. The generator of claim 13 wherein said phase-compensating waveplate comprises at least one compensator having an e-axis.

16. The generator of claim 15 wherein said turning element has a vertex axis and wherein said waveplate e-axis has an orientation with respect to said vertex axis selected from a group consisting of a substantially parallel orientation and a substantially perpendicular orientation.

17. The generator of claim 13 wherein said at least one element comprises a plurality of elements, each of said elements having an e-axis that has an orientation to prevent mode mixing as said beam travels from a first of said elements to a second of said elements.

18. The generator of claim 17 wherein any of said e-axes has an orientation with respect to any other of said e-axes selected from a group consisting of a substantially parallel orientation and a substantially perpendicular orientation.

19. The generator of claim 13 wherein said light beam has a wavelength and said second amount of polarization retardation causes said turning assembly to add approximately an integral number of said wavelengths.

20. The generator of claim 1 wherein said turning element is a two-part prism that comprises a first prism part and a second prism part and has a vertex axis, wherein said turning assembly further comprising a mixing half wave waveplate located between said first and second prism parts, and wherein said waveplate has an e-axis orientation with respect to said vertex axis of about ±45 degrees.

21. The generator of claim 1 wherein said fixed DGD stage comprises at least one passive birefringent element.

22. The generator of claim 21 wherein said beam has a direction within said at least one element and said at least one element is at least one birefringent element exhibiting a birefringence in a plane perpendicular to said direction.

23. The generator of claim 22 wherein said at least one birefringent element is cut so that the extraordinary crystalline axis is oriented substantially in said plane.

24. The generator of claim 21 wherein said at least one element comprises a plurality of birefringent elements, each of said birefringent elements having a birefringent axis that has an orientation to prevent mode mixing as said beam travels from a first of said elements to a second of said elements.

25. The generator of claim 24 wherein any of said birefringent axes has an orientation with respect to any other of said birefringent axes selected from a group consisting of a substantially parallel orientation and substantially perpendicular orientation.

26. The generator of claim 25 wherein said turning assembly has a vertex axis and any of said birefringent axes has an orientation with respect to said vertex axis selected from a group consisting of a substantially parallel orientation and a substantially perpendicular orientation.

27. The generator of claim 26 further comprising a mixing half wave waveplate having an e-axis with an orientation with respect to said vertex axis selected from a group consisting of about +22.5 degrees, about −22.5 degrees, about +67.5 degrees, and about −67.5 degrees.

28. The generator of claim 21 wherein said at least one element comprises a material selected from a group consisting of yttrium ortho-vanadate, lithium niobate, rutile, calcite, alpha-barium borate, mica, crystalline quartz, and a combination thereof.

29. The generator of claim 21 wherein said at least one element comprises a combination of a first element having a first thermal expansion coefficient and a second element having a second thermal expansion coefficient, each of said elements comprising at least one material, wherein said combination has a thermal expansion coefficient that is less than said first and second coefficients individually.

30. The generator of claim 29 wherein said first element comprises a first birefringent material having a first length and said second element comprises a second birefringent material having a second length, wherein said first and second lengths have a length ratio based on said first and second thermal coefficients.

31. The generator of claim 30 wherein said first element is comprises yttrium ortho-vanadate and said second element comprises lithium niobate.

32. The generator of claim 21 wherein said fixed DGD stage has an optical length and said at least one element comprises a plurality of birefringent elements, and wherein one of said plurality of birefringent elements comprises at least one auxiliary birefringent element having a birefringence that is relatively small compared with the other of said plurality of elements to fine-tune said optical length.

33. The generator of claim 32 wherein said auxiliary element comprises a crystalline quartz material.

34. The generator of claim 1 wherein said turning assembly has a vertex axis and said fixed DGD stage has a birefringent axis that has an orientation of about 45 degrees with respect to said vertex axis.

35. The generator of claim 1 wherein said variable retardation stage comprises at least one electro-optic element constructed from an electro-optic material selected from a group consisting of lithium niobate, potassium titanium phosphate, rubidium titanium phosphate, rubidium titanium arsenate, lead zirconium lanthanum, and any combination thereof.

36. The generator of claim 35 wherein said beam has a direction within said at least one element and said at least one element exhibits a voltage-induced birefringence in a plane perpendicular to said direction.

37. The generator of claim 35 wherein said at least one electro-optic element comprises a plurality of electro-optic elements, each of said electro-optic elements having a p-axis that has an orientation to substantially prevent mode mixing as said beam travels from a first of said electro-optic elements to a second of said electro-optic elements.

38. The generator of claim 37 wherein any of said p-axes has a relative orientation with respect to any other of said p-axes selected from a group consisting of a substantially parallel orientation and a substantially perpendicular orientation.

39. The generator of claim 38 wherein said turning assembly has a vertex axis and any of said p-axes has an orientation with respect to said vertex axis selected from a group consisting of a substantially parallel orientation and a substantially perpendicular orientation.

40. The generator of claim 1 wherein said variable retardation stage comprises two groups of at least one electro-optic element having an anode and a cathode, each element having an intrinsic birefringence and a voltage-induced birefringence that occurs when a voltage is applied between said anode and said cathode, and wherein said groups are oriented such that said first group intrinsic birefringence cancels said second group intrinsic birefringence and said first group voltage-induced birefringence adds to said second group voltage-induced birefringence.

41. The generator of claim 40 wherein said variable retardation stage further comprises a mixing halfwave waveplate between said first group and said second group.

42. The generator of claim 40 wherein said first group has a voltage-induced birefringence major axis and said mixing half-wave waveplate has an e-axis, and wherein said first group e-axis has an orientation of about 45 degrees with respect to said major axis.

43. The generator of claim 40 wherein said first group at least one element and said second group at least one element are substantially the same and oriented in substantially the same directions, and said group voltages are applied in opposite directions.

44. The generator of claim 39 wherein a first group anode voltage is substantially the same as said second group cathode voltage and said first group cathode voltage is substantially the same as said second group anode voltage.

45. The generator of claim 1 wherein said variable retardation assembly further comprises a mixing half wave waveplate located between said fixed DGD stage and said variable retardation stage, wherein (1) said turning assembly has a vertex axis, (2) said variable retardation stage has a voltage-induced p-axis that has an orientation with respect to said vertex axis selected from a group consisting of a substantially parallel orientation and a substantially perpendicular orientation, (3) said fixed DGD stage has a birefringent axis that has an orientation with respect to said vertex axis selected from a group consisting of a substantially parallel orientation and a substantially perpendicular orientation, and (4) said mixing half-wave waveplate has an e-axis orientation with respect to said vertex axis selected from a group consisting of about +22.5 degrees, about −22.5 degrees, about +67.5 degrees, and about −67.5 degrees.

46. The generator of claim 1 wherein said turning assembly has a vertex axis and said fixed DGD stage has a birefringent axis having an orientation with respect to said vertex axis of about 45 degrees, and wherein said variable retardation stage has a voltage-induced birefringent axis having an orientation with respect to said vertex axis selected from a group consisting of a substantially parallel orientation and a substantially perpendicular orientation.

47. A method for generating PMD comprising:
adding a variable amount of retardation to said light beam, said variable amount of retardation comprising a first amount of retardation due to an intrinsic birefringence of a variable retardation stage and a second amount of retardation due to a voltage-induced birefringence of said variable retardation stage;
redirecting said light beam, through a turning assembly, back toward said variable retardation stage; and
further adding to said light beam, through said variable retardation stage, another first amount of retardation due to said intrinsic birefringence such that said two first amounts cancel, and another second amount of retardation due to said voltage-induced birefringence such that said two second amounts add.

48. The method of claim 47 further comprising:
adding, through a fixed DGD stage, a fixed amount of DGD to said light beam before said adding; and
adding, through said fixed DGD stage, a fixed amount of DGD to said light beam after said further adding.

49. The method of claim 48 wherein said fixed DGD stage comprises a plurality of crystals comprising at least two complimentary types of crystals, each type having a different temperature dependence, and wherein said adding a fixed amount of retardation and said adding the same fixed amount of retardation comprises adding complimentary amounts of retardation with said two types of crystals.

50. The method of claim 49 wherein said first and second types of crystals have a first and a second birefringence, respectively, and wherein said plurality of crystals further comprises a third type of crystal having a birefringence that is less than said first and second birefringences, wherein said adding a fixed amount of retardation and said adding the same fixed amount of retardation further comprises adding a predetermined differential amount of retardation when said light passes through said third type of crystal to ensure that said fixed amount is accurate.

51. The method of claim 47 wherein said turning assembly further comprises a phase-compensating waveplate along the optical path of said generator and said turning prism provides a first amount of polarization retardation to the optical beam, and wherein said method further comprises substantially nullifying the first amount of polarization retardation by providing a second amount of polarization retardation.

52. The method of claim 51 wherein said second amount of polarization retardation is equal in magnitude to and opposite in direction from the first amount of retardation.

53. The method of claim 51 wherein said light beam has a wavelength and said second amount of polarization retardation causes said turning assembly to add approximately an integral number of said wavelengths.

54. A method for generating PMD using a device comprising a lens assembly for receiving a light beam from an input fiber and providing said light beam to an output fiber, a beam-turning assembly for redirecting the light beam from said input fiber to said output fiber, and a variable PMD generating assembly located between the lens assembly and the beam-turning assembly, wherein said PMD generating assembly comprises a fixed DGD stage and a variable retardation stage, said method comprising:
providing a light beam through said input fiber into said lens assembly;
directing said beam through said variable PMD generating assembly at least twice by folding the beam with said turning assembly, such that said light beam can undergo mode mixing; and
receiving said light beam through said output.

55. A PMD compensator comprising:
a polarization controller that can be optically coupled to an optical input fiber;
a PMD generator comprising a lens assembly for receiving a light beam from said input fiber and providing said light beam to an output fiber, a beam-turning assembly for redirecting the light beam from said input fiber to said output fiber, and a variable PMD generating assembly located between the lens assembly and the beam-turning assembly, wherein said PMD generating assembly comprises a fixed DGD stage and a variable retardation stage;
a receiver and error generator having an input optically coupled to an output of the PMD generator; and
a control signal generator having an input optically coupled to said receiver and error generator and an output coupled to the polarization controller and the PMD generator.
